(19) United States
(12) Patent Application Publication
(10) Pub. No.: US 2013/0297590 A1
(43) Pub. Date: Nov. 7, 2013

(54) DETECTING AND PRESENTING INFORMATION TO A USER BASED ON RELEVANCY TO THE USER'S PERSONAL INTEREST

(71) Applicants: Eli Zukovsky, Somerville, MA (US); Vadim Ivanov, St. Petersburg (RU); Brent Stanley, Hingham, MA (US)

(72) Inventors: Eli Zukovsky, Somerville, MA (US); Vadim Ivanov, St. Petersburg (RU); Brent Stanley, Hingham, MA (US)

(21) Appl. No.: 13/859,671

(22) Filed: Apr. 9, 2013

Related U.S. Application Data
(60) Provisional application No. 61/686,572, filed on Apr. 9, 2012.

(51) Int. Cl. G06F 17/30

(52) U.S. Cl. CPC G06F 17/30554
USPC 707/722

(57) ABSTRACT

The invention performs predictive analytics on web content for users researching or tracking detailed topics on the web who are limited by the sparse input capability of current search tools. Using a machine learning technology core and other predictive analytics tools, the invention allows users to create predictive models based on exemplars of their interest such as articles and documents. Predictive models are mathematically patterned and pointed at the web. Results are presented to the user, with the ability to re-train the system as desired as well as create new models.

### RELATED APPLICATIONS

This application claims the benefit of U.S. Provisional Patent Application Ser. No. 61/686,572, entitled “Automated Methods of Detecting and Presenting Information to the User based on Relevancy to the User's Personal Interests and Methods of Sharing Personalized Views among Peers”, filed by Zukovsky et al. on Apr. 9, 2012, the contents of which hereby incorporated by reference in its entirety.

This application is related to U.S. Non-Provisional Patent Application Ser. No. (Atty. Docket No. 92981-311640), entitled “Peer Sharing of Personalized Views of Detected Information based on Relevancy to a Particular User's Personal Interests”, filed by Zukovsky et al. on Apr. 9, 2013, the contents of which hereby incorporated by reference in its entirety.

### TECHNICAL FIELD

The present invention relates generally to computer-implemented information searching, and, more particularly, to intelligent presentation of search results to end-users is based on relevancy.

### BACKGROUND

Users who perform a large amount of internet research, such as lawyers, professional researchers, marketers, and business intelligence professionals all suffer from the same condition: being unable to achieve the desired degree of precision in locating relevant content on the web, which increases costs associated with manual review of data while missing critical data that is “lost in the weeds”. In general, online searches sort through data chaos and unstructured data to return results to the user. For instance, the problem of data chaos is resident in the corporate environment, in various business sectors, and is reflected in data sitting on the web and social media. The returned results, however, are often just as chaotic and unstructured as the originating data, as current methods are limited to keyword-based hunt-and-peck use of search engines.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer system/network;

FIG. 2 illustrates an example computer;

FIG. 3 illustrates an example enhanced search results view as described herein;

FIG. 4 illustrates an example RSS feed as described herein;

FIG. 5 illustrates an example view of processes and supporting services as described herein;

FIG. 6 illustrates an example of processes and associated algorithms as described herein;

FIG. 7 illustrates an example of the steps that may be implemented by the system to deliver the desired results as described herein;

FIGS. 8A-8B illustrate an example of social clustering as described herein and

FIGS. 9-25 illustrate an example implementation of the techniques described herein.

### DETAILED DESCRIPTION OF EXAMPLE EMBODIMENTS

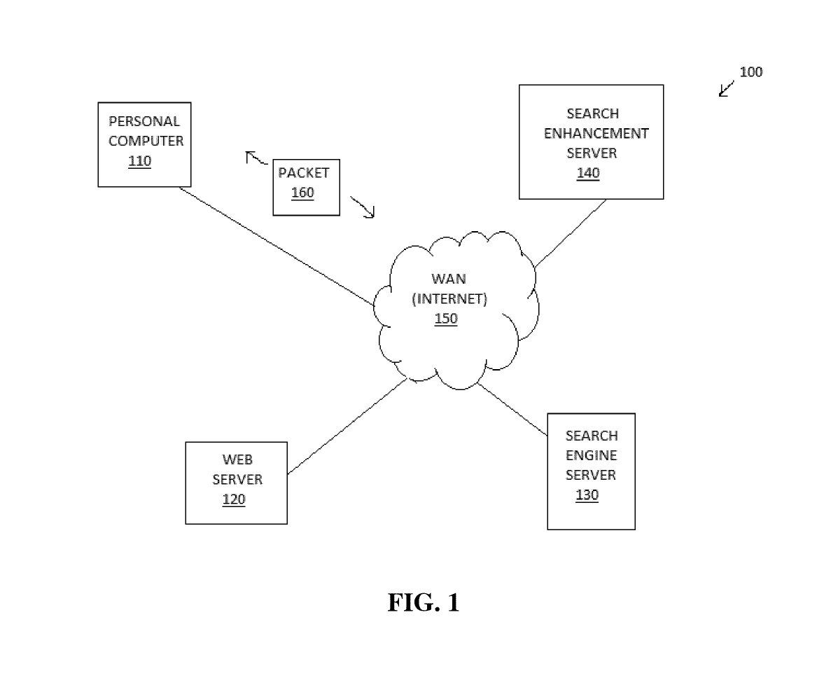

A computer network is a geographically distributed collection of devices interconnected by communication links for transporting data between the devices, such as personal computers, servers, or other devices. FIG. 1 is a schematic block diagram of an example simplified computer network 100 illustratively comprising one or more personal computers (e.g., desktops, laptops, tablets, smartphones, etc.) 110, web servers 120, search engine servers 130, and/or search enhancement server 140 interconnected over a wide area network, such as the Internet 150. Those skilled in the art will understand that any number of devices, links, etc. may be used in the computer network, and that the view shown herein is for simplicity. Further, data packets 160 (e.g., traffic and/or messages sent between the devices) may be exchanged among the devices of the computer network 100 using predefined and generally known network communication protocols.

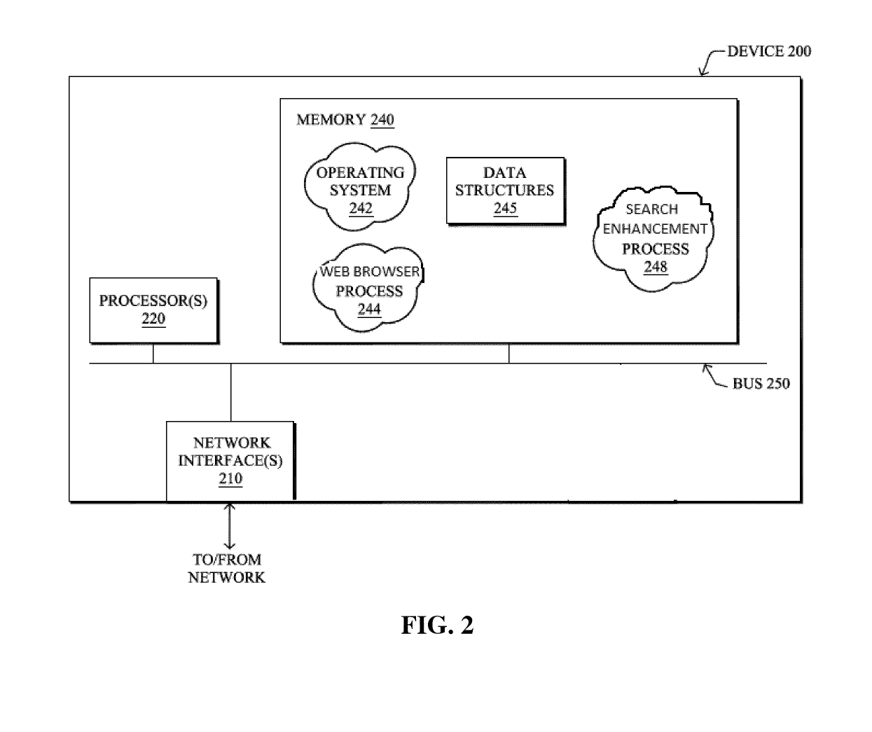

FIG. 2 is a schematic block diagram of an example simplified device 200 that may be used with one or more embodiments described herein, e.g., as personal computer 110 or search enhancement server 140 as shown in FIG. 1 above, depending upon the functionality being performed herein. The device may comprise one or more network interfaces 210 (e.g., wired and/or wireless, at least one processor 220, and a memory 240 interconnected by a system bus 250. The network interface(s) 210 contain the mechanical, electrical, and signaling circuitry for communicating data over links coupled to the network 100. The memory 240 comprises a plurality of storage locations that are addressable by the processor 220 for storing software programs and data structures 245 associated with the embodiments described herein. The processor 220 may comprise hardware elements or hardware logic adapted to execute the software programs and manipulate the data structures. An operating system 242, portions of which are typically resident in memory 240 and executed by the processor, functionally organizes the device by, inter alia, invoking operations in support of software processes and/or services executing on the device. These software processes and/or services may comprise a web browser process 244 and an illustrative “enhanced searching” process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Illustratively, the techniques described herein may be performed by hardware, software, and/or firmware, such as in accordance with the web browser process 244 and/or enhanced searching process 248, each of which may contain computer executable instructions executed by the processor 220 to perform functions relating to the techniques described herein. For example, web browser process 244 may be executed on a personal computer 110 to access a web site hosted by web browser process 244 of the search enhancement server 140. Also, the enhanced searching process 248 may operate in conjunction with the web browser process 244 on the server 140 to perform one or more specific search and presentation techniques described herein. Notably, while particular processes are shown, other suitably functioning processes may be configured in accordance with the techniques herein, and the arrangement shown and described herein is merely one example implementation.

The techniques herein provide a practical application of machine learning and information extraction technologies in order to create enhanced search results and an efficient presentation of those results to a user. Specifically, as described in detail below, the technology performs predictive analytics on web content for users researching or tracking detailed topics on the web who are limited by the sparse input capability of current search tools. Using a machine learning technology core and other predictive analytics tools, the technology allows users to create predictive models based on exemplars of their interest such as articles and documents. Predictive models are mathematically patterned and pointed at the web. Results are presented to the user, with the ability to re-train the system as desired as well as create new models.

As described herein, the inventive techniques address the issues of:
Accuracy, and the need to improve upon false positive and false negative performance;
The need to scale to very large data volumes;
The ability to leverage user-held exemplars to define relevancy; and
The ability to customize based on user interests.

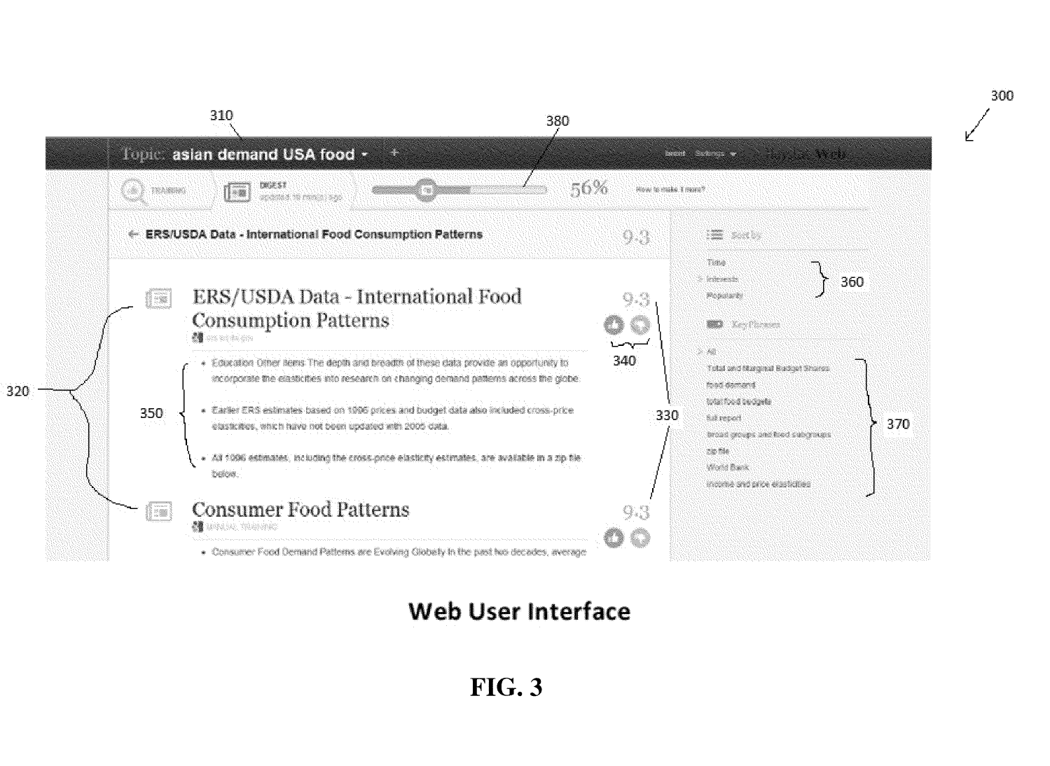

Specifically, with reference to example results image 300 of FIG. 3, a user identifies a topic 310 (e.g., “Asian demand USA food”) and may inputs relevant “seed” content of locally-held documents or search-engine results (e.g., a website previously found that the user thought held pertinent information). As such, the enhanced searching process 248 creates a mathematical model based on the input which is directed at the web (e.g., other web servers and/or search engine servers) and other data sources. Once located, the results 320 (e.g., articles, websites, etc.) are presented to the user with a relevancy score 330, while allowing the user to retrain (“fine tune”) the search as necessary to improve results (e.g., using thumbs up/down buttons 340). Additionally, the system presents extractive summaries 350 of each result, reducing review time. Sort filters 360 are available (e.g., by relevance, time, interest, popularity, etc.), and a list of key phrases 370 may be used to select search results that share various phrases pulled is from the located search results. As also described below, a model quality indicator 380 may provide insight to the user regarding how “trained” the system is to locate relevant search results.

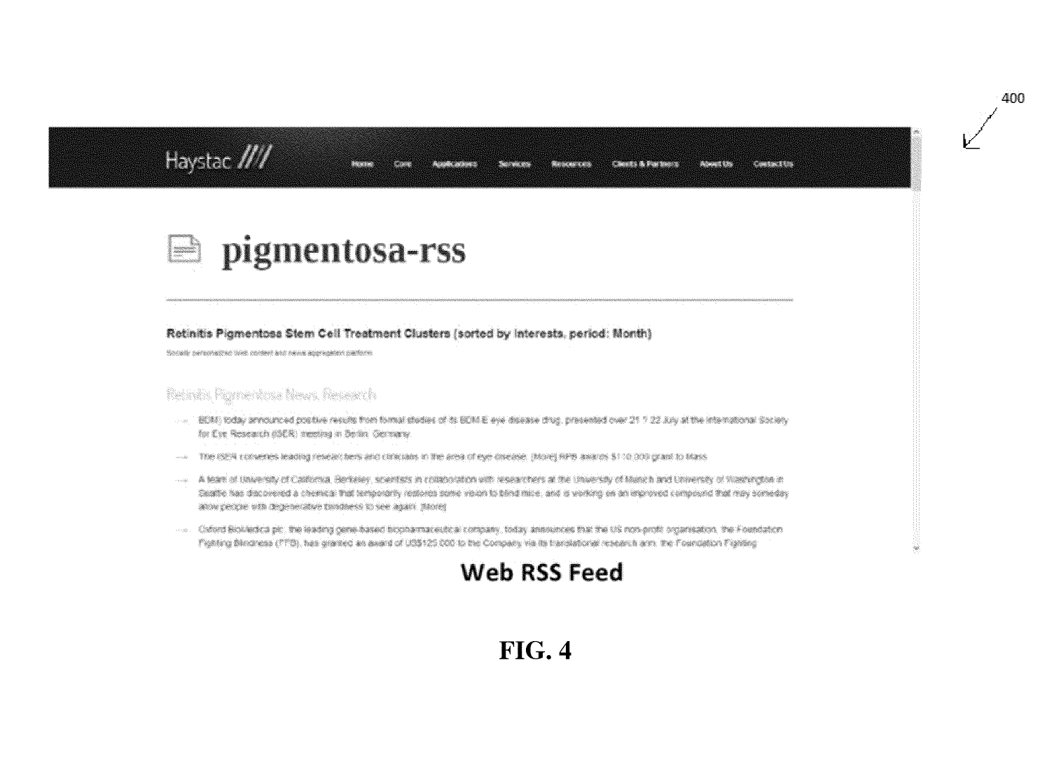

In addition, in one or more embodiments as illustrated in FIG. 4, an RSS (Rich Site Summary) feed 400 may be generated by the system and made available to the user in order to keep track of newly updated search results (e.g., blog postings, news articles, etc.) as they are populated and detected by the system (e.g., real time searching).

The present invention applies machine learning and information extraction technologies for useful purposes across the following spectrum of services:
Web services;
Enterprise services;
Legal services;
Local services; and
Digest services.

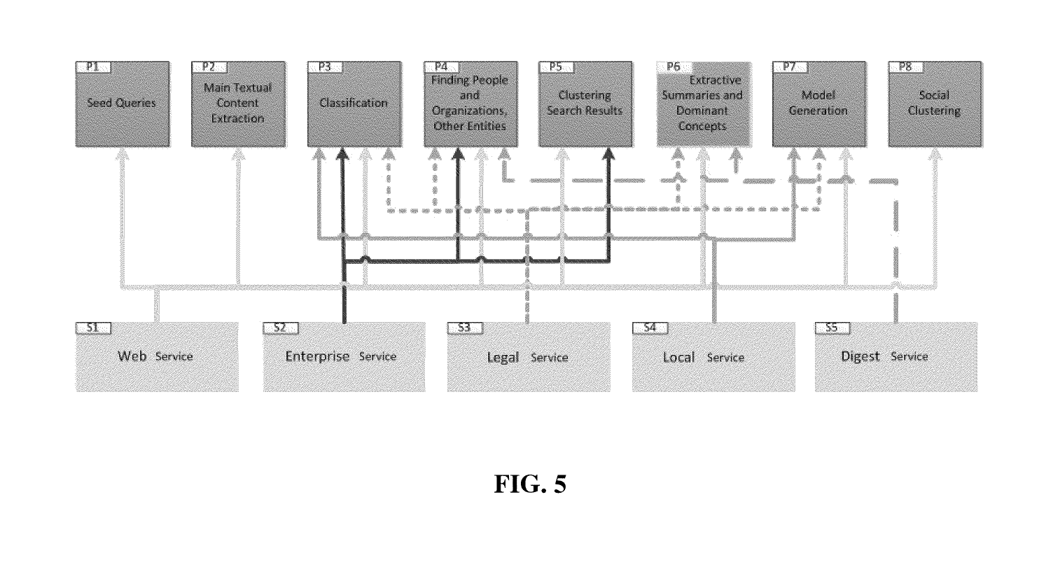

Each of these services share the technology core of the invention described herein, but each serve a different master in answering the question of relevancy. The relationship of the processes to the service is illustrated in FIG. 5. In particular, in FIG. 5, each process is numbered P1-P8, while the differentiated arrows show which process is used to support each service S1-S5, illustrating the ability to leverage the core across multiple services, as described in greater detail below.

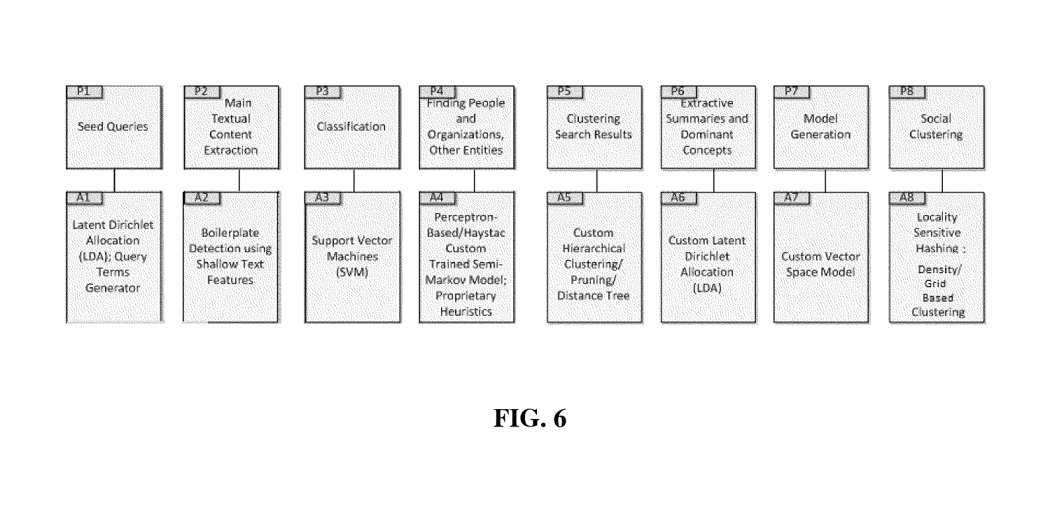

Moreover, in FIG. 6, the relationship of processes P1-P8 to their associated algorithms A1-A8 is shown, with additional detail described below.

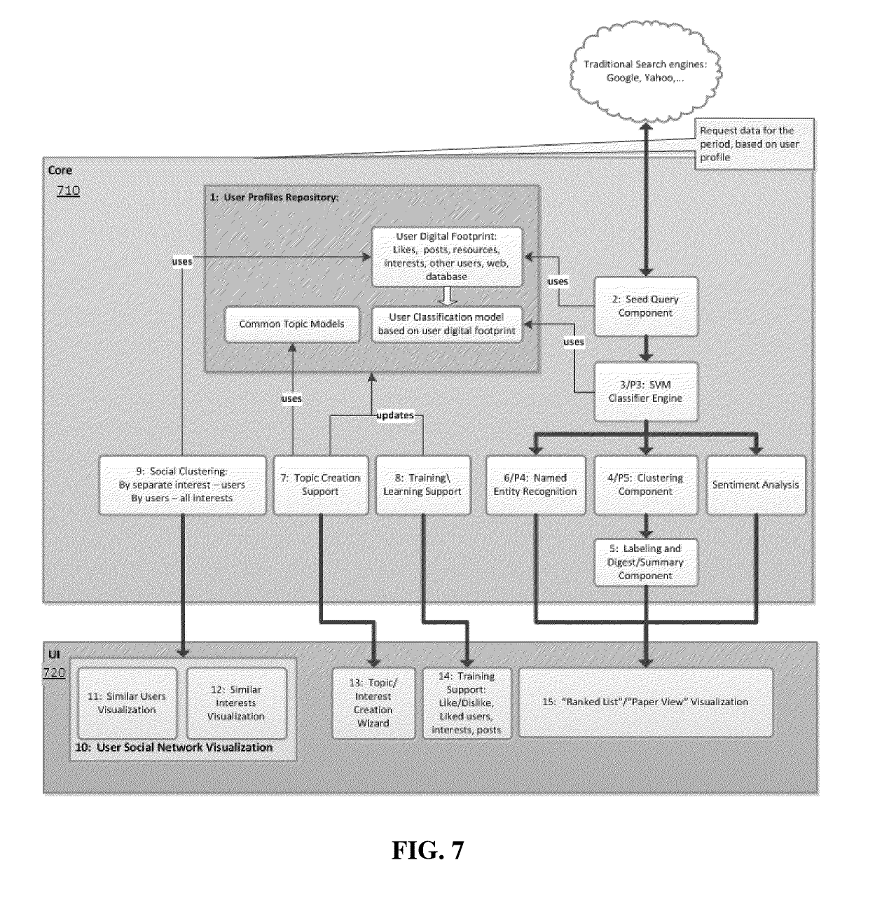

Operationally, the core architecture integrates the processes for scalability to large quantities of data to support the delivery of services. FIG. 7 illustrates the numbered steps 1-15 that may be implemented by the system to deliver the desired results, as described below:
1: Users Profile Repository stores users' digital footprint, generated Vector Space Model (“VSM”) based on the user digital footprint and extendable is common topic pre-trained vector space model; e.g., world, business, sport, art, or science.
2: Seed Query (P1) generates relevant query terms based on user digital footprint and runs the time-range query against a search engine index using API's, e.g., GOOGLE, YAHOO, BING, etc.
3: Support Vector Machine (“SVM”) (P3) uses generated VSM to classify data stream resulting from the seed query.
4: Clustering (P5) component takes query result set that is either classified or timeline based and applies clustering algorithms to combine search results based on semantic proximity under the most relevant label which is automatically generated.
5: Labeling and Digest sub-component generates extractive summary of the clustered documents and assigns the most relevant label to the cluster.
6: Named Entity Recognition and Classification (“NERC”) (P4) component extracts entities from result set and classifies them to Person Name, and Organization. The most popular entities are displayed as Trend Setters on the system's dashboard (interface). The popularity is defined as the number of times that certain entity is mentioned in the result set.
7: Topic Creation component via Topic Creation Wizard updates user digital footprint with new topic of interest optionally using predefined (featured) Common Topics Models.
8: Training/Learning component by interacting with the user via dashboard, where user identifies interesting and not interesting documents for the particular topic, updates user digital footprint with the learning examples for particular topic.
9: Social Clustering: This term refers to the component which applies clustering algorithm on user's digital footprints and detects similar users or users with similar interests, and feeds generated social graphs to the dashboard.
10: Users Social Network Visualization creates a map of the users and is their shared interest connections across common social networks such as LINKEDIN, FACEBOOK, and others, and by processing their individual digital footprint characteristics.
11: Similar Users Visualization is the process of creating a visual map of the individual user relationships to each other by processing their individual digital footprint characteristics.
12: Similar Interests is the identification of similar interests between users or groups of users based on digital footprints, or similar clusters of users, where the shared interests are both outright and intuited based on predicted interest.
13: Topic Wizard is the presentation of outright and intuited topic candidates to a user for the user's review and acceptance or rejection. Selection is performed through a binary “thumbs up/thumbs down” feature.
14: Training is the process of selecting relevant exemplars from the world and using these exemplars as the basis for defining their interests and creating their digital footprints.
15: Ranked List/Paper View Visualization is the presentation of probabilistically scored and ranked results in a news format which makes the essence of the found document easy to deduce.

Referring again to FIG. 6, processes P1-P8 and algorithms A1-A8 will now be described.

Starting with P1, the Seed Query, either a Latent Dirichlet Allocation (LDA) algorithm or a Nouns Extraction algorithm for a Query Terms Generator may be used. In either case, the Seed Query generation process comprises an innovative use of digital profile collection of documents (learning examples, group sourcing, etc.) to generate terms for queries to the Web (e.g., GOOGLE API). It also provides initial intelligent filtering of the result set for further granular classification.

For the LDA model specifically, the LDA model breaks down the collection of documents into topics representing the document as a mixture of topics. It could be viewed as low-dimensional representation of the documents in user profile. The Seed is Query generation process in the LDA model comprises:
Creating a topic model from the documents in user profile;
Selecting higher probability terms from the most relevant topics (based on topic probability distribution); and
Generating a search query (e.g., GOOGLE API) based on the most relevant terms collected in the previous steps within the parameterized time range.

When the embodiment comprises a query terms generator, the Seed Query generation process comprises:
Identifying nouns in positive and negative examples of particular topic training set;
Computing, for each noun from positive examples, the noun's rank based on a ratio of its probability in positive examples and its probability in negative examples. In case it is missing in negative examples its rank defined as a max rank of existing nouns;
Selecting N nouns with max rank; and
Generating a search query (e.g., GOOGLE API) based on the most relevant nouns collected in the previous steps within the parameterized time range.

For process P2, the Main Textual Content Extraction, algorithm A2 comprises Boilerplate Detection using Shallow Text Features. In particular, algorithms are used to detect and remove the surplus “clutter” (boilerplate, templates) around the main textual content of a web page. It improves quality of clustering and classification by eliminating noise from the page and thus allows applying clustering and classification to the relevant datum of the whole page.

Continuing to process P3, Classification, application A3 may comprise a Support Vector Machine (SVM). Empirical studies and internal experiments show that pairwise coupling combining posterior probabilities method (e.g., a Pairwise Coupling-Proximal Support Vector Machine or “PWC-PSVM”) is superior compare to commonly used is winner-takes-all (WTA) and one versus one implemented by max-wins voting (MWV). Note that multi-class SVM may be used to classify filtered result set (seed queries) based on a selected category model.

Process P4 is configured to find people and organizations in a document, using algorithm A4, such as a perceptron-based discriminatively trained Semi-Markov Model (SMM) as a Named Entities (NE) extraction method and improving feature quality using distributional similarity. The techniques herein apply proprietary heuristics to improve scalability of the algorithm implementation by defining variable length spans (e.g., between 4 (default) and 8) based on trigger words from the training corpus that are the most frequent words that are characteristic in defining NE classes. It also excludes from the analysis sequences that never appear as NE in training corpus. In general, the method provides necessary mechanisms to identify and extract named entities from the text. It is used to maintain trendsetters that are popular people and organizations on the Web for the requested period.

Process P5 clusters search results using algorithm A5, Hierarchical Clustering with Pruning based on Distance Tree and Threshold. It applies extensions to the feature set using 2-gram shingles for better representation of terms sequences and a term frequency-inverse document frequency (TF-IDF) of the terms and shingles. Note that it is important to collect dispersed documents within result set under the same contextual umbrella. Implementation of the hierarchical (agglomerative) clustering herein achieves this goal.

P6 is a process that creates an extractive summary and dominant concepts, such as by using algorithm A6, illustratively a Latent Dirichlet Allocation (LDA). In particular, the extractive summary of the corpus and derived concepts cloud allows user to rely on the machine-generated summary of the corpus rather than read entire article that could be time consuming and sometimes infeasible for the large corpus or very large documents within the corpus.

Model Generation process P7 may use either a Vector Space Model (VSM) is algorithm or Latent Dirichlet Allocation (LDA) for algorithm A7. In particular, a unique feature selection may be based on shingles and pruned “Bag of Words”. The feature vectors comprise the model generated from learning example reflecting user interests in a particular subject (category) within the user digital profile. In addition, process P7 and algorithm A7 process data from the Web in a manner that otherwise poses additional challenges for classification and clustering of sparse and short texts. For example, Web search snippets, forum and chat messages, blog and news feeds, book and movie summaries, product descriptions, and customer reviews, etc. It also required to minimize an amount of training (small training sets) and subsequent fast classification. In order to address the aforementioned challenges the illustrative Vector Space Model (VSM) herein is extended with additional features that are derived based on the following process:
(a) Choosing an appropriate Universal Dataset. It is paramount to the process and could be as broad as WIKIPEDIA or could be very domain specific (e.g., large dataset of Legal documents for Legal domain);
(b) Performing topic analysis for the universal dataset. It boils down to LDA-based topic estimation of the given universal dataset (illustratively, it is done only once for the given domain). The result is the estimated topic model for the given domain;
(c) Performing a topic inference for training and future data. Generated estimated topic models may be used for feature extraction from a digital profile and future data: the system performs topic inference based on an estimated topic model for each document. The result is a mixture of topics or topic distribution for the given document that are integrated into the document feature vector.

Social clustering, described in above-referenced application Ser. No. (Atty. Docket No. 92981-311640), is performed by process P8 using an algorithm A8 such as Locality Sensitive Hashing (LSH) or Density/Grid Based Clustering. Generally, scalability is paramount to provide efficient social clustering of potentially millions of users. Known clustering algorithms make use of some distance similarity (e.g., cosine similarity) to measure pairwise distance between sets of vectors that would not scale (n̂k time complexity with n points and k features). However, using LSH functions create is short fingerprints of vectors where closer vectors have similar fingerprints (and may reduce time complexity to O(nk+n log n)). In addition, LSH converts the problem of finding a cosine distance between two vectors to the problem of finding hamming distance between bit streams, and is an order of magnitude faster, memory efficient, and allows for dimensionality reduction. Density/Grid Based Clustering, on the other hand, is the method of clustering the most suitable for Social Clustering task. The system persists the hyper-cube structure and associated profiles/documents. If required (for example change in user profile) the clustering object will be moved to different hyper-cube and the neighbors will be re-calculated.

According to the techniques herein, a digital footprint is the collection of information about a user who has built a profile based on their interests. The digital footprint has ramifications for the system user as well as people and topics under their umbrella of interests. The system defined herein maintains a digital footprint for each user containing the following components:
Interest and non-interest in the certain content (RSS, Web, Blogs, etc.) within the search enhancement system described herein (learning examples);
Imported digital footprints by navigating through system users with common interests detected by social clustering; and
Crowd sourcing, i.e., postings at social media (e.g., TWITTER, FACEBOOK, etc.).

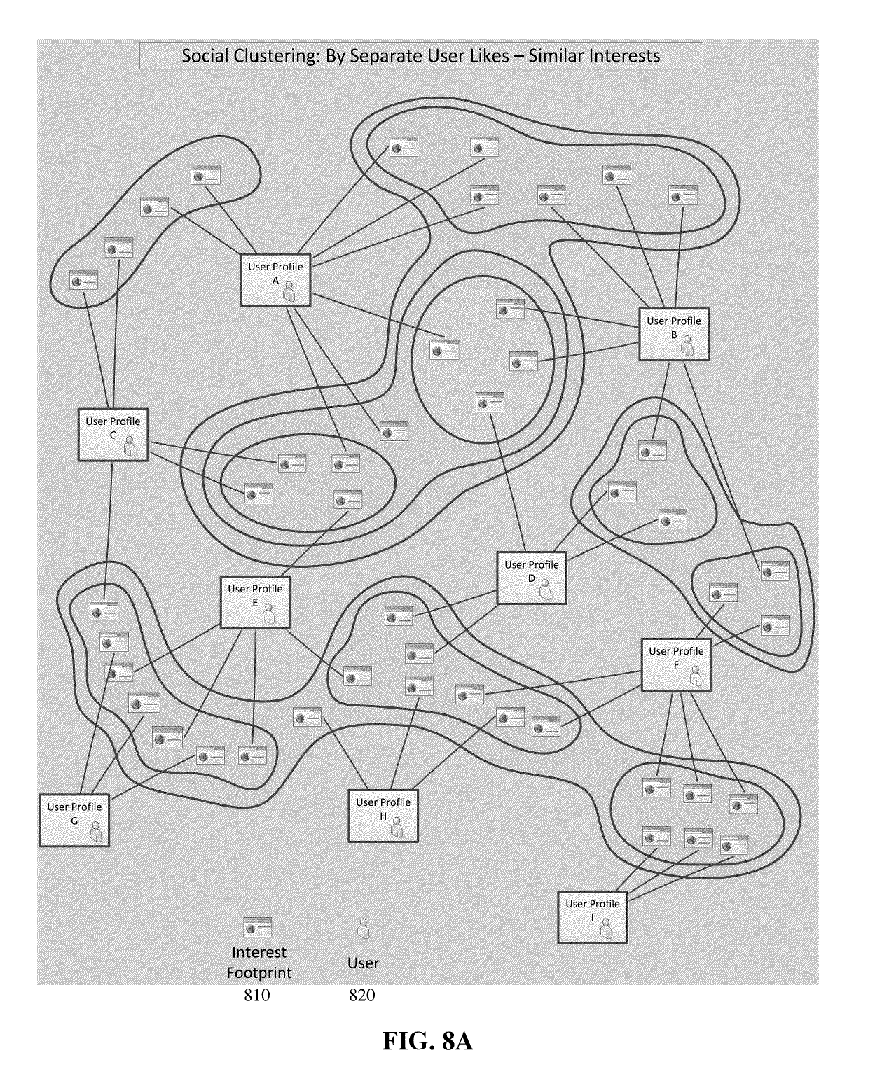

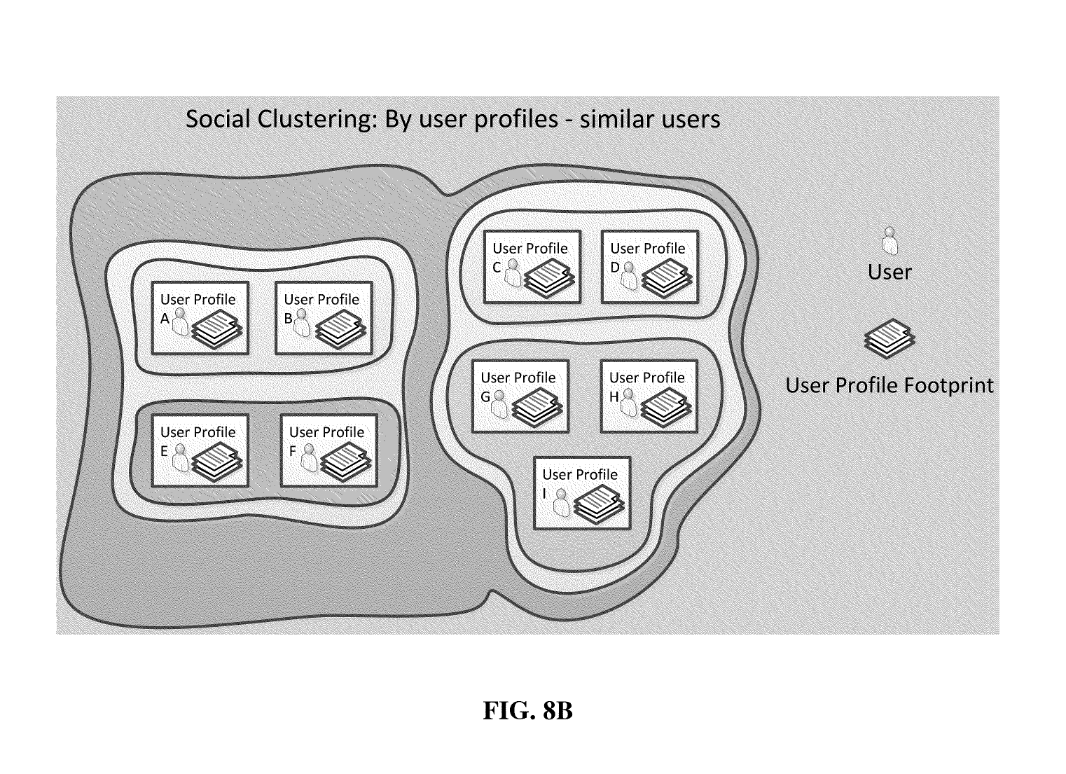

For social clustering, the invention automatically detects users based on common interest and overlapping subject matter, and users interested in a certain topic. It also provides mechanisms to share topics amongst peers within and outside the system where the topic is a view model generated based on the digital footprint, as described in above-referenced application Ser. No. (Atty. Docket No. 92981-311640), which references FIGS. 8A and 8B in more detail.

In addition, the techniques herein provide for timeline seed queries. In particular, cutting through the vast postings space in the GOOGLE search index, even with limited (e.g., up to a month) time range, could be extremely inefficient and may even be practically impossible. The techniques herein, therefore, introduce the notion of a seed is query that provides concise filtering of the document space before subsequent fine granular classification based on the user model. For instance, seed queries may be generated based on a dominant set of terms from the user digital footprint.

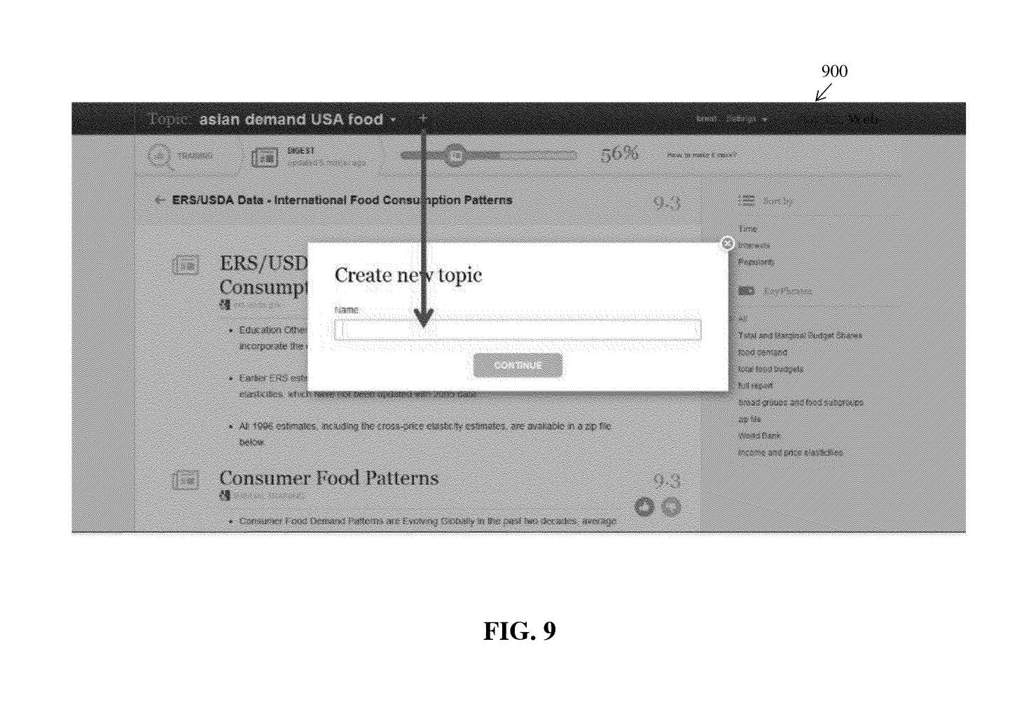

FIGS. 9-25 illustrate an example implementation of the techniques described herein, such as a user-experience of the embodiments herein.

In FIG. 9, the user may first be prompted to name the desired topic, such as by selecting a particular icon (e.g., the “+” symbol) in a user interface 900 to present an editor to insert the desired topic.

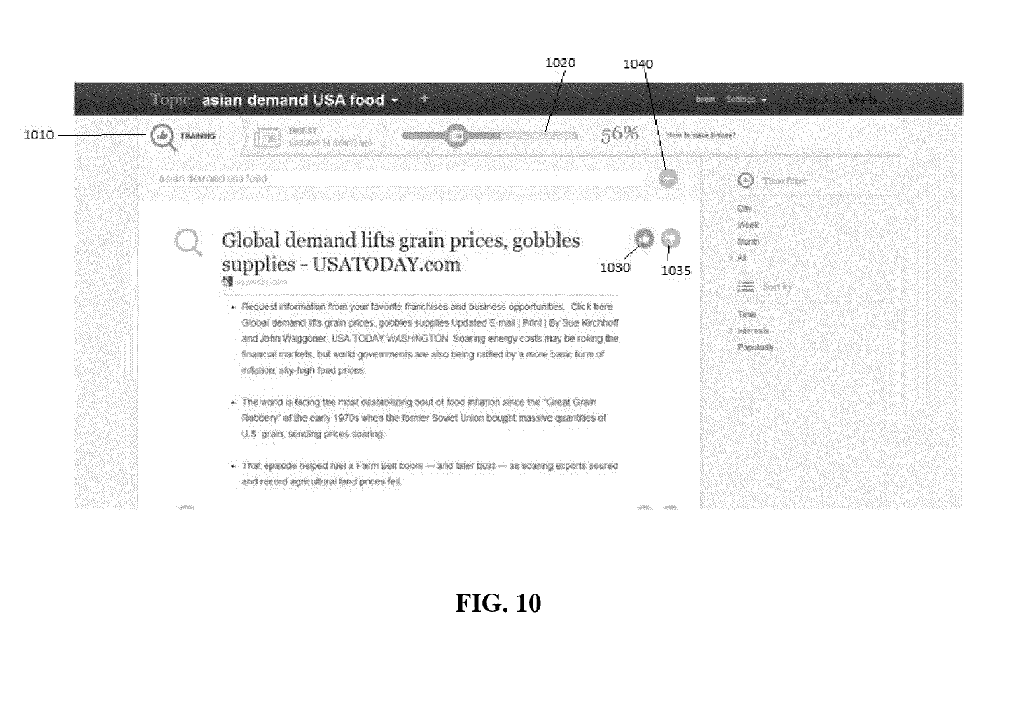

In FIG. 10, the system may search for seed articles, such as by prompting a user through a “training” tab 1010 to enter key words which bring potentially relevant articles pertaining to their topic within a search bar 1020. Relevant articles can then be added to the training set for this topic by selecting “thumbs up” (1030), while clicking “thumbs down” (1035) removes irrelevant articles, accordingly. Clicking on the headline for any result presents the user with the source web page with the associated content. (Selecting a browser back button brings the user back to the previous screen.)

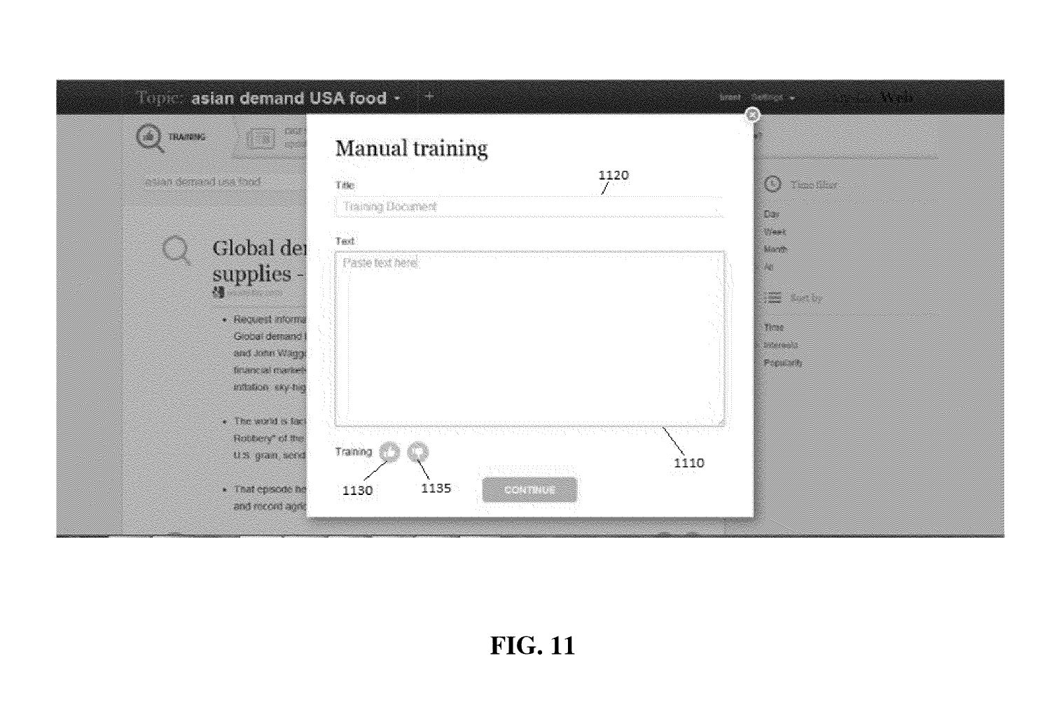

In particular, to add a local document as a training document, clicking on the “+” sign 1040 next to the search bar exposes an editor as shown in FIG. 11, where content from locally held documents can be pasted in box 1110 (or else the document may be uploaded in its entirety, including hyperlinks to relevant websites). Illustratively, the name of the item may be inserted in field 1120, and then the user may click on “thumbs up” 1130 or “thumbs down” 1135 to add to the training set.

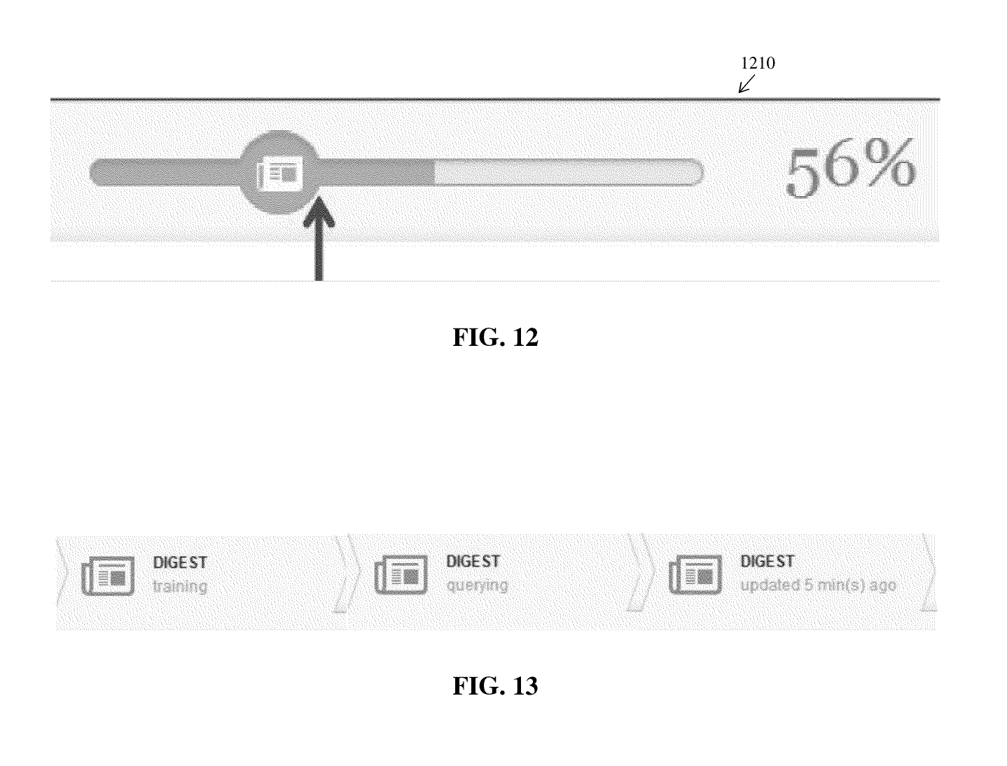

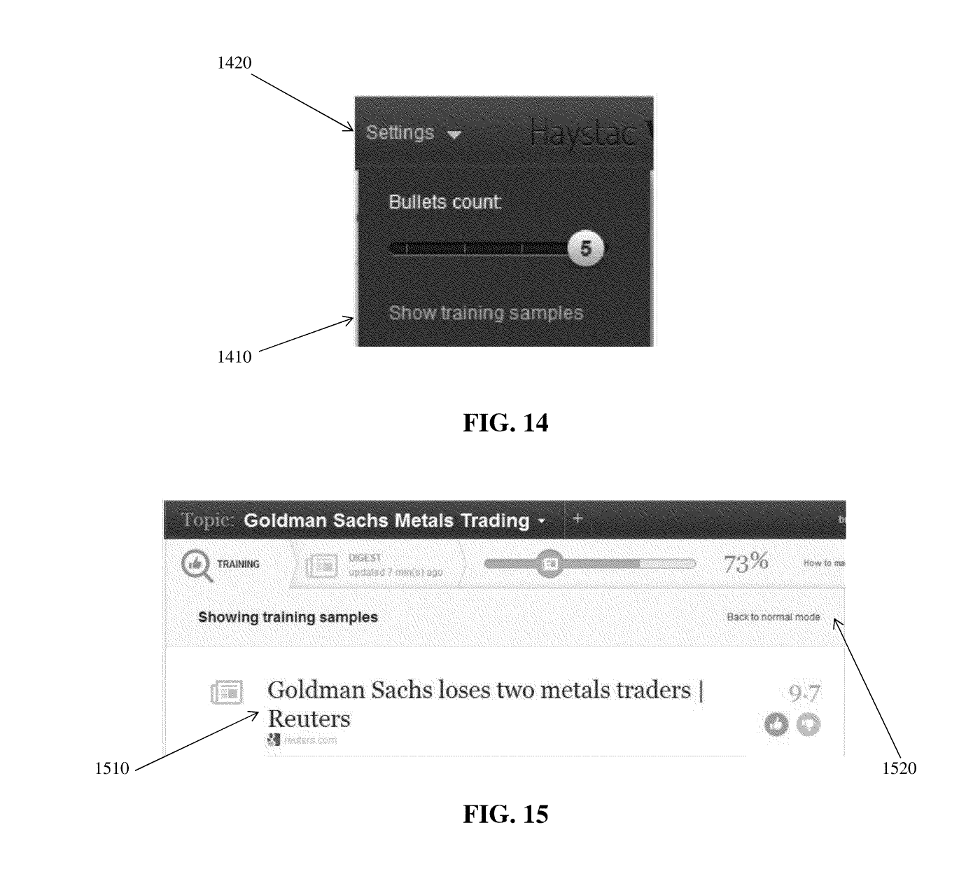

The techniques herein also provide feedback on the quality of the predictive model being built via an illustrative “thermometer” gauge 1210 in FIG. 12 (e.g., the model quality bar 380 in the user interface). Illustratively, the gauge requires at least five positive examples and five negative examples to start building a model. Additional positive examples may be used if they are available. The bar 1210 starts from the left and builds to the right as model quality improves. When it reaches the edge of the illustrative circle, as indicated by the arrow, model quality is expected to yield decent quality results. Additional training will continue to improve the model, where the percentage (e.g., 56%) is indicates a relative measure of quality. While the model is building in the web system herein, the system provides a status indicator in the Digest tab, which means that results will be available once training is completed. As an example, this currently takes from 1-3 hours, depending on the amount of data being processed. The digest statuses shown in FIG. 13 (training, querying, latest update) are provided in sequence, and in one embodiment, results may be available once the last stage has been reached. To view of the current predictive model, as shown in FIG. 14, the current articles and documents for each model can be seen by clicking on the “Show Training Samples” link 1410 within a “Settings” tab 1420. When viewing the samples in FIG. 15, the link 1510 brings the user to the list for the model they are in, and they may scroll through the list and make new decisions as appropriate to add and/or delete content to/from the model. Clicking on “Back to Normal Mode” (link 1520) brings the user to the main training tab.

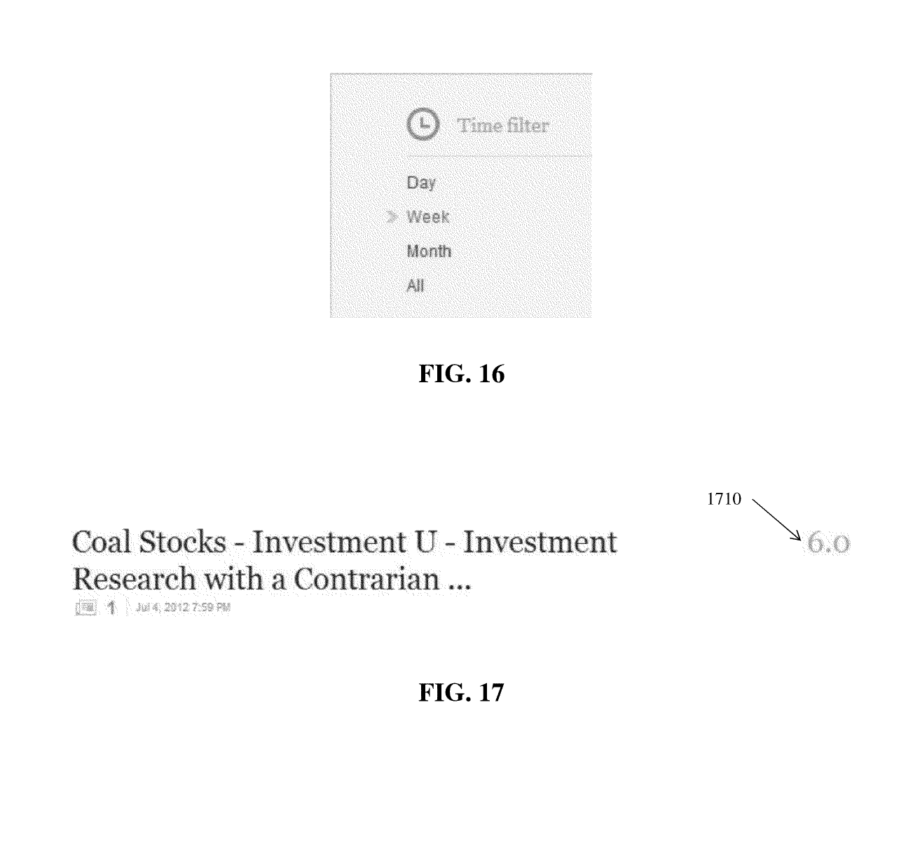

The results may be viewed within the Digest tab, and may be filtered using the time filter as shown in detail in FIG. 16 (e.g., day, week, month, year, all, etc.). As shown in FIG. 17 (and above), the results may be presented in order of relevance ranking, with the ranking score 1710 indicated next to each result.

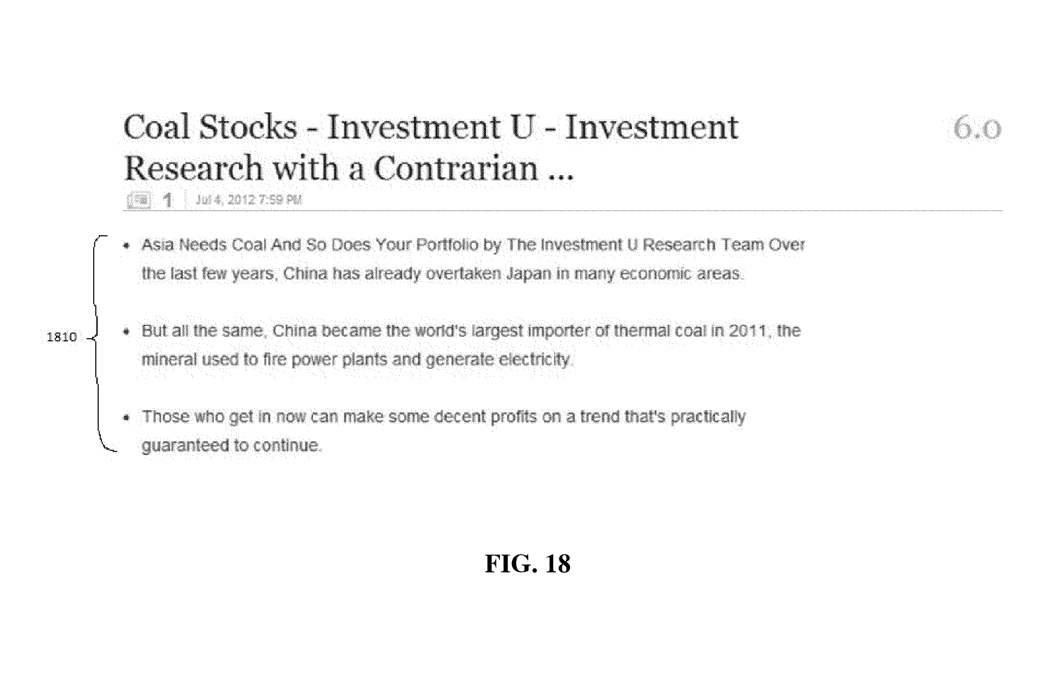

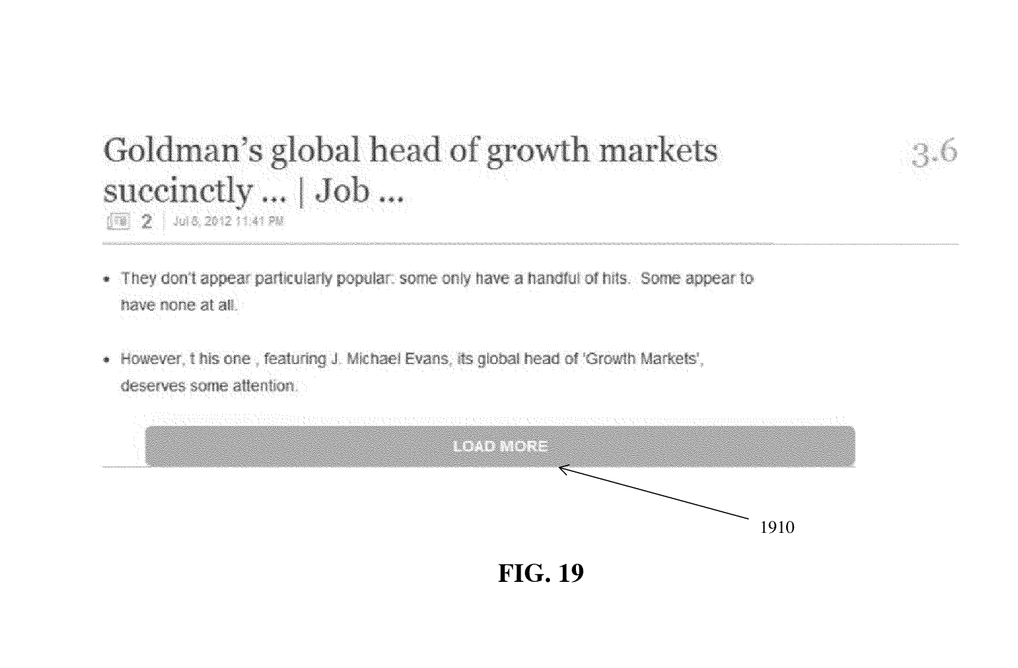

Furthermore, as mentioned above, the services described herein generate an extractive summary for each result (1810 in FIG. 18), which is a machine-generated list of the determined most important sentences found in each article to facilitate and speed the understanding of the article. To see more results, the user may scroll down the list and select a “Load More” link (1910 in FIG. 19) to see additional results.

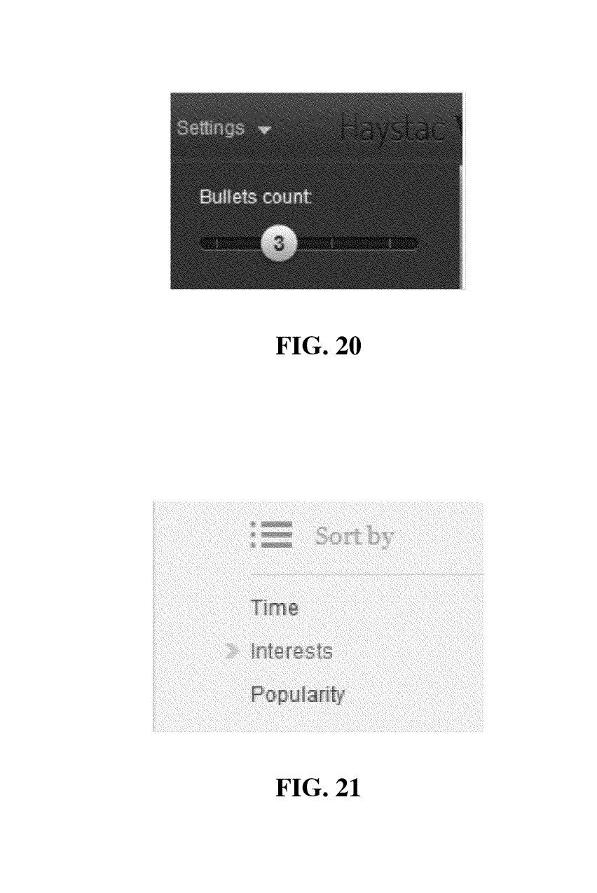

Note that as shown in FIG. 20, the number of sentences in the review summaries can be adjusted in the settings mode (bullet count slider 2010), and has an illustrative range of 2-5 sentences (sliding the button increases or decreases the number). Additional sort options are available as shown in FIG. 21, in addition to Interests (an illustrative default setting). For instance, “Time” displays results based on most recent results, while “Popularity” displays results which are most often viewed based on web data statistics.

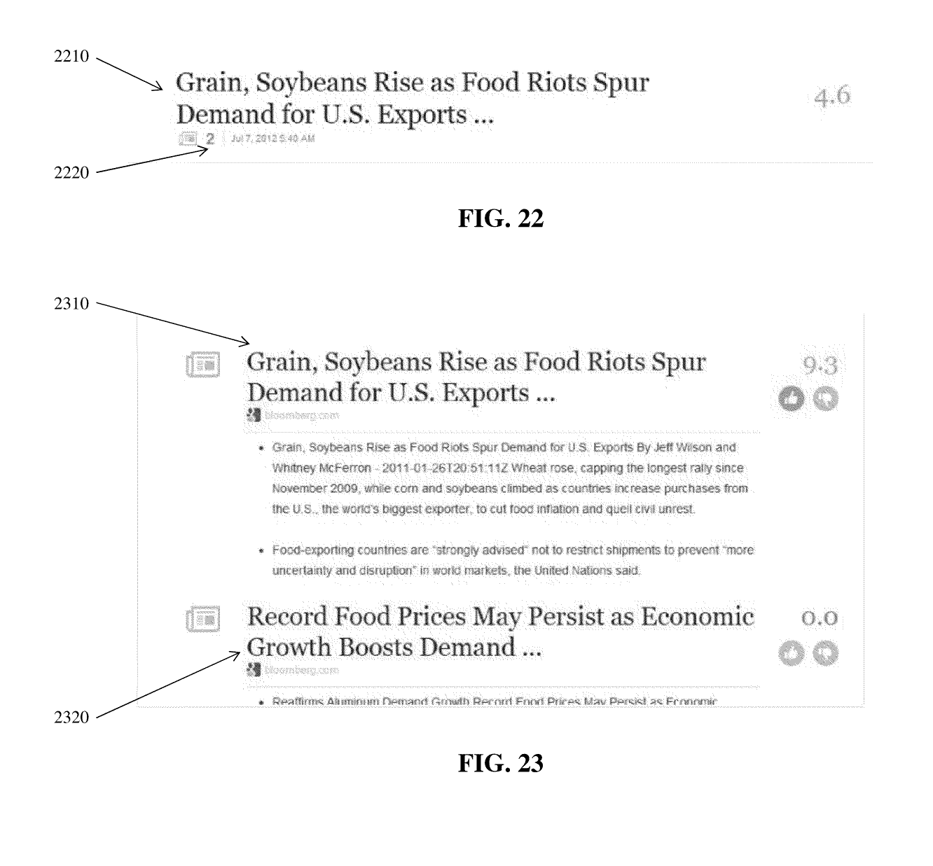

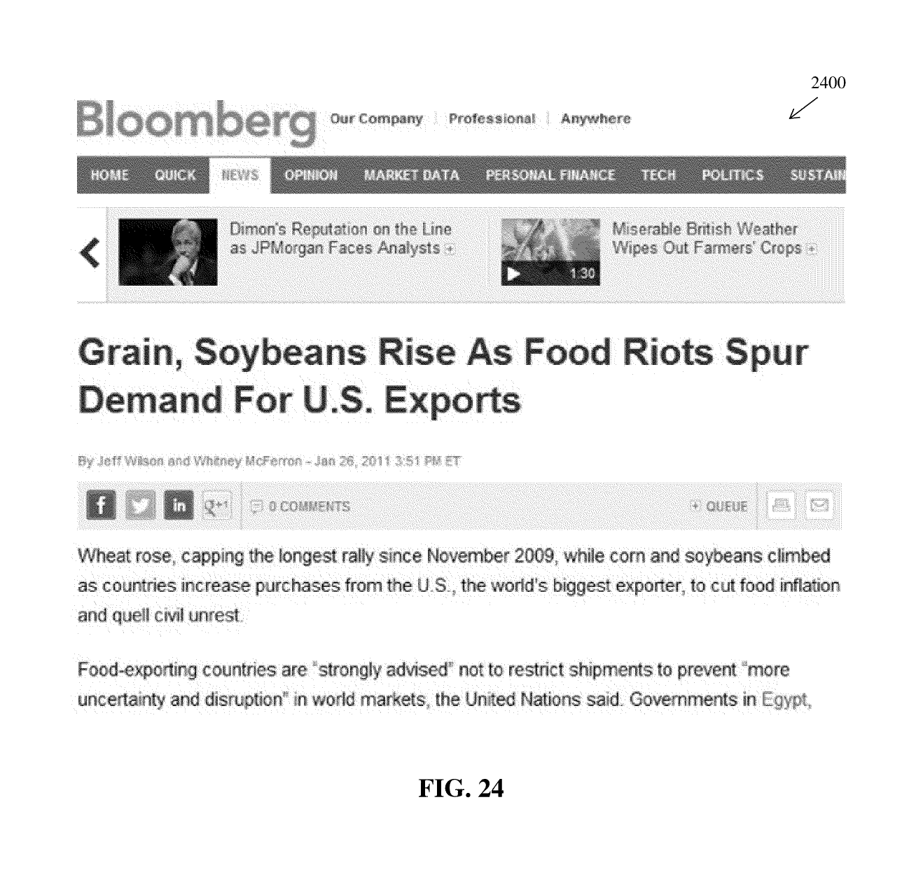

In addition to listing individual headlines, the techniques herein may also generate clusters of results (similar results) with a number of results indicated under the headline. For instance, as shown in FIG. 22, a given headline 2210 may have a number 2220 is indicating the number of clustered results. Clicking on the headline 2210 brings the user to the list of articles within the cluster, as shown in FIG. 23 (articles 2310 and 2320). The article itself can be accessed by clicking on the headline for any article (e.g., 2310), bringing the user to the web page containing the content, as shown in FIG. 24 (site 2400).

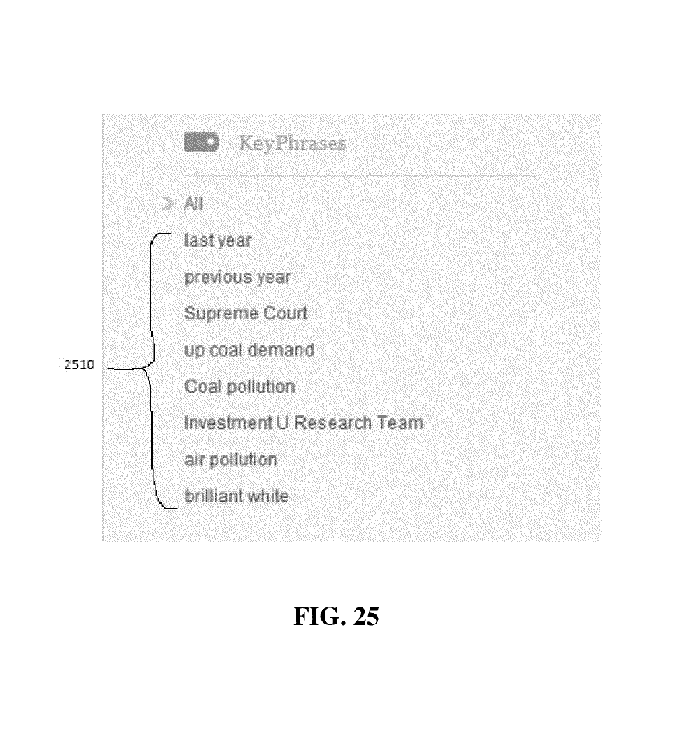

According to one or more illustrative embodiments herein, the system herein may self-generate key phrases from the results for a topic, which may displayed in a list in the user interface, such as shown in FIG. 25. Clicking on a key phrase brings the user to the articles containing that phrase. Illustratively, the number of key phrases in the list 2510 may vary from between 3-10 items, depending on the content.

Advantageously, the techniques described herein, therefore, detect and present information to a user based on relevancy to the user's personal interests. peer sharing of personalized views of detected information based on relevancy to a particular user's personal interests (“social clustering”). In particular, the techniques herein improve the quality of information being tracked for specific issues, concepts, or opportunities, and achieve better results faster and at a lower cost using user-created predictive model(s). Specifically, the techniques herein improve relevancy of results by leveraging the availability of exemplars and machine learning capabilities, and allows users to more readily understand the individual document contents by answering the question “What do I have?” through summarization of the content. Notably, better understanding of content improves several business processes (such as in the legal and compliance areas of research) and allows policies to be applied to data, thus reducing manual labor associated with document review.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the is embodiments herein. Therefore, it is the object of the appended claims to cover all such variations and modifications as come within the true spirit and scope of the embodiments herein.

What is claimed is:

1. A method as shown and described.

2. An apparatus as shown and described.

3. A tangible, non-transitory computer-readable medium having program instructions stored thereon, the program instructions, when executed by a processor, operable to perform a method as shown and described.
